(19) United States
(12) Patent Application Publication
(10) Pub. No.: US 2014/0191564 A1
(43) Pub. Date: Jul. 10, 2014

(54) RIM, AIRLESS TIRE AND HUBCAP DESIGNS CONFIGURED TO DIRECTIONALLY CONVEY AIR AND METHODS FOR THEIR USE

(71) Applicant: Gary Gebeau, Chalfont, PA (US)

(72) Inventor: Gary Gebeau, Chalfont, PA (US)

(21) Appl. No.: 13/735,146

(22) Filed: Jan. 7, 2013

(51) Int. Cl. B60B 7/00; B60C 7/00; B60B 31/00; B60B 15/00

(52) U.S. Cl. CPC B60B 7/002; B60B 15/00; B60C 7/00; B60B 31/00
USPC 301/37.101; 301/41.1; 152/246; 29/894.3

(57) ABSTRACT

The present turbine fan rim, turbine fan airless tire and turbine fan hubcap designs are configured to remove air from under the underside of a moving vehicle when rotated in a particular direction, typically in a forward direction. This air movement can create a vacuum below the vehicle, which can create a down force on the vehicle increasing traction between the vehicle's tires and the road surface and lowering the vehicle's center of gravity. This downward force and partial vacuum can thus increase as the rotational velocity of the tires increases, providing greater traction at higher speeds. An additional benefit to these wheel, airless tire, and hubcap designs is the cooling effect that would be created by the flowing air on brake parts that are located near wheels of nearly all vehicles.

### FIELD OF THE INVENTION

The present rim, airless tire an hubcap designs can comprise spokes, supports or similar structures configured to operate as turbine fan vanes, which can move air from under a vehicle as the vehicle moves forward. The movement of air from under the vehicle creates a partial vacuum under the vehicle, which generates a downward force which acts to pull the vehicle body towards the ground lowering the vehicle's center of gravity. This downward force presses each of the wheels against the ground resulting in increased traction and vehicle stability. The volume of air moved increases as speed increases due to fact that the wheels and turbine fan vanes rotate at higher RPMs (revolutions per minute) as speed increases. The result is the creation of a more powerful vacuum under the vehicle at higher speeds when greater traction and stability are required most. The present rim, airless tire and hubcap designs can also create increased airflow over the brakes, which provides the additional benefit of cooling brake surfaces, thus improving their performance and the vehicle's overall stopping capability.

### BACKGROUND

The present rims, airless tires and hubcaps are designed to increase traction between a vehicle and the road. Spoilers have been widely used for this same purpose by creating downward force on the vehicle as air passes over the spoiler. Spoilers are commonly added to the front and/or rear sections of a vehicle to improve traction and ground contact. In the absence of air spoilers or similar devices, such as air dams, increased forward velocity creates airflow around and under the vehicle body, creating lift. This lift reduces traction between the vehicle and the road surface, which is highly undesirable and can create an extremely hazardous driving condition. Some spoilers act to break the air flow around the vehicle, such as the air dams mentioned above, reducing the amount of lift created while others create a downward force, which increases traction by offsetting the upward force of the lift. Specifically, rear spoilers create a downward force on the rear axle, improving traction between the rear wheels and the road and front spoilers located at the underside of the front of the car, disrupt airflow as it travels beneath the car, creating a partial vacuum, which can cause the vehicle body to be pulled toward the ground, increasing traction between all wheels and the road.

Although both types of spoilers provide some downward force on a vehicle, thus increasing traction, neither is an ideal solution. Specifically, front spoilers (air dams) are often located close to the ground where they can easily be damaged by uneven road surfaces. Additionally, the ability to retract these spoilers is minimal at best. Rear spoilers can be designed to be more adaptable to changes in speed and improvements have been made to allow some rear spoilers to retract at slower speeds and increase their pitch at higher speeds to optimize the downward force as speed increases. However, these spoilers are located on the back end of a vehicle, and depending on the type of vehicle, may not be visually appealing to the owner and can be an obstacle that reduces the driver's rear visibility. Moreover, this location does not allow for the downward force to be evenly distributed over the entire length of the vehicle. Therefore, a new apparatus and system is needed to increase traction at all four wheels, which can also be aesthetically pleasing.

The present rim and tire designs can also be used to address another problem, namely, the overheating of brake components. Friction between the brake pads and brake discs or drums creates a significant amount of heat. When the braking components reach sufficiently high temperatures, braking performance can be degraded significantly. For this reason hubcaps and rims with a solid front surface are no longer used even though they are more capable of resisting damage to brake components than those with openings in them. These openings in the front surface of a rim allow for air flow through the hubcap or rim of a vehicle, which then cools the brakes. Some of these rims and hubcaps have been designed so that air flows from outside of the car inward under the car, causing the air to flow over the brake surfaces to prevent overheating. The present rim and hubcap designs move air in the opposite direction, but would be configured to move volumes of air vastly greater than that moved by openings typically found in currently available rims and hubcaps, which could also act to significantly cool brake surfaces.

In addition to rim and hubcap designs, airless tires have recently been devised that can comprise a hub and spoke design. The spokes comprising such airless tires could also be modified to create turbine fan vanes. Due to the fact that these vanes would be located further from the center of the wheel, where rotational velocity is greatest, such modification of these airless tires has the potential to move much larger volumes of air than that moved by the modified rims described above. Although the modified rim designs or modified airless tire designs could be used independently to create down force on a vehicle and increase traction and stability, both of these devices could also be used together on the same wheel to increase traction even further. Additionally, the present rim, hubcap and airless tire devices can also be used in conjunction with front or rear spoilers enhancing the functionality of both.

What is needed are rim, hubcap and airless tire designs that can be configured to increase a vehicle's traction as its speed increases, lower the vehicle's center of gravity, as well as provide cooling airflow over brake components. These rim, hubcap and airless tire designs should be visually attractive and should not require modifications to the design of a vehicle's body.

### SUMMARY OF THE INVENTION

An aspect of the present device is to provide rim, hubcap and airless tire designs that can increase a vehicle's traction and lower its center of gravity as its speed increases and provide cooling airflow over brake components.

These aspects can be obtained by a turbine fan rim or hubcap comprising: an inner hub comprising an outer surface and a first diameter; an outer rim comprising an inner surface as well as a curbside edge and a car side edge and a second diameter wherein the second diameter of the outer rim is greater than the first diameter of the inner hub and wherein the outer rim is located circumferentially about the inner hub; and at least one turbine fan rim vane or turbine fan hubcap vane comprising a first end and a second end, wherein the first end of each turbine fan rim vane or turbine fan hubcap vane is connected to the outer surface of the inner hub and the second end of each turbine fan rim vane or turbine fan hubcap vane is connected to the inner surface of the outer rim and wherein at least one turbine fan rim vane or turbine fan hubcap vane is configured to move air in a particular direction when the inner hub and the outer rim are both rotated in a first direction.

These aspects can also be obtained by a turbine fan airless tire airless tire comprising: an inner band comprising an inner surface and an outer surface and a first diameter; an outer band comprising an inner surface and an outer surface as well as a curbside edge and a car side edge and a second diameter wherein the second diameter of the outer band is greater than the first diameter of the inner band and wherein the outer band is located circumferentially about the inner band; and at least one turbine fan airless tire vane comprising a first end and a second end, wherein the first end is connected to the outer surface of the inner band and the second end is connected to the inner surface of the outer band and wherein at least one turbine fan airless tire vane is configured to move air in a particular direction when the inner band and outer band are both rotated in a first direction.

These aspects can also be obtained by a method for using a turbine fan rim or turbine fan hubcap, the method comprising: providing at least one turbine fan rim comprising: an inner hub having an outer surface and a first diameter; an outer rim having an inner surface as well as a curbside edge and a car side edge and a second diameter wherein the second diameter of the outer rim is greater than the first diameter of the inner hub and wherein the outer rim is located circumferentially about the inner hub; and at least one turbine fan rim vane or turbine fan hubcap vane comprising a first end and a second end wherein the first end of each turbine fan rim vane or turbine fan hubcap vane is connected to the outer surface of the inner hub and the second end of each turbine fan rim vane or turbine fan hubcap vane is connected to the inner surface of the outer rim and wherein at least one turbine fan rim vane or turbine fan hubcap vane is configured to move air in a particular direction when the inner hub and the outer rim are both rotated in a first direction; providing a vehicle having a port side, a starboard side and an underside wherein air is located under the underside; connecting at least one turbine fan rim to the vehicle so that rotating the inner hub and outer rim of the turbine fan rim in the first direction will cause the air located under the underside of the vehicle to be removed from under the underside of the vehicle; and rotating the turbine fan rim in the first direction.

These aspects can also be obtained by a method for using a turbine fan airless tire, the method comprising: providing at least one turbine fan airless tire comprising: an inner band comprising an outer surface and a first diameter; an outer band comprising an inner surface, a curbside edge, a car side edge and a second diameter wherein the second diameter of the outer band is greater than the first diameter of the inner band and wherein the outer band is located circumferentially about the inner band; and at least one turbine fan airless tire vane comprises a first end and a second end wherein the first end of each turbine fan airless tire vane is connected to the outer surface of the inner band and the second end of each turbine fan airless tire vane is connected to the inner surface of the outer band and wherein at least one turbine fan airless tire vane is configured to move air in a particular direction when the inner band and the outer band are both rotated in a first direction; providing a vehicle having an underside and air located under the underside; connecting at least one turbine fan airless tire to the vehicle so that rotating the inner band and outer band of the turbine fan airless tire in the first direction will cause the air located under the underside of the vehicle to be removed from under the underside of the vehicle; and rotating the turbine fan airless tire in the first direction.

### BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1 is a perspective view of a left (port) side turbine fan rim design according to an embodiment;

FIG. 2 is a perspective view of a right (starboard) side turbine fan rim design according to an embodiment;

FIG. 3 is a partial cross sectional perspective view of the front of a left (port) side turbine fan rim design shown in FIG. 1 according to an embodiment;

FIG. 4A is a cross sectional top view of the left (port) side turbine fan rim design shown in FIG. 1 according to an embodiment;

FIG. 4B is a cross sectional top view of the left (port) side turbine fan rim design shown in FIG. 1 according to an embodiment;

FIG. 5 is a perspective view of a left (port) side turbine fan airless tire design mounted on a standard rim wherein the airless tire's tread has been made transparent allowing the turbine fan vanes to be viewed according to an embodiment;

FIG. 6 is a perspective view of a right (starboard) side turbine fan airless tire design mounted on a standard wheel rim wherein the airless tire's tread has been made transparent allowing the turbine fan vanes to be viewed according to an embodiment;

FIG. 7A is a cross sectional view of the left (port) side turbine fan airless tire design as shown in FIG. 5 according to an embodiment;

FIG. 7B is a cross sectional view of the left (port) side turbine fan airless tire design as shown in FIG. 5 according to an embodiment;

FIG. 8 is a perspective view of a left (port) side turbine fan airless tire design mounted on a standard rim wherein the airless tire's tread has been made transparent allowing the turbine fan vanes to be viewed according to an alternative embodiment;

FIG. 9 is a perspective view of a right (starboard) side turbine fan airless tire design mounted on a standard rim wherein the airless tire's tread has been made transparent allowing the turbine fan vanes to be viewed according to an alternative embodiment;

FIG. 10 is a top cross sectional view of the left (port) side turbine fan airless tire design as shown in FIG. 8 according to an alternative embodiment;

FIG. 11 is a top view of a vehicle comprising the present turbine fan rims and/or turbine fan airless tires showing air flow created by the turbine fan rims and/or airless tires according to an embodiment;

FIG. 12 is a perspective view of a left (port) side turbine fan rim design according to a first alternative embodiment;

FIG. 13 is a perspective view of a right (starboard) side turbine fan rim design according to a first alternative embodiment;

FIG. 14 is a perspective view of a left (port) side turbine fan rim design according to a second alternative embodiment;

FIG. 15 is a perspective view of a right (starboard) side turbine fan rim design according to a second alternative embodiment;

FIG. 16 is a perspective view of a left (port) side turbine fan rim design according to a third alternative embodiment;

FIG. 17 is a perspective view of a right (starboard) side turbine fan rim design according to a third alternative embodiment;

FIG. 18 is a perspective view of a left (port) side turbine fan airless tire design mounted on a standard rim wherein the airless tire's tread has been made transparent allowing the turbine fan vanes to be viewed according to a first alternative embodiment;

FIG. 19 is a perspective view of a right (starboard) side turbine fan airless tire design mounted on a standard wheel rim wherein the airless tire's tread has been made transparent allowing the turbine fan vanes to be viewed according to a first alternative embodiment;

FIG. 20 is a perspective view of a left (port) side turbine fan airless tire design mounted on a turbine fan rim wherein the airless tire's tread has been made transparent allowing the turbine fan vanes to be viewed according to an embodiment;

FIG. 21 is a perspective view of a right (starboard) side turbine fan airless tire design mounted on a turbine fan rim wherein the airless tire's tread has been made transparent allowing the turbine fan vanes to be viewed according to an embodiment;

FIG. 22 is a perspective view of a left (port) side turbine fan airless tire design mounted on a turbine fan rim wherein the airless tire's tread has been made transparent allowing the turbine fan vanes to be viewed according to an alternative embodiment;

FIG. 23 is a perspective view of a right (starboard) side turbine fan airless tire design mounted on a turbine fan rim wherein the airless tire's tread has been made transparent allowing the turbine fan vanes to be viewed according to an alternative embodiment;

FIG. 24 is a perspective view of a left (port) side turbine fan hubcap design configured to be mounted on a standard rim according to an embodiment;

FIG. 25 is a perspective view of a right (starboard) side turbine fan hubcap design configured to be mounted on a standard rim according to an embodiment;

FIG. 26 is a partial cross sectional perspective view of the front of a left (port) side turbine fan hubcap design shown in FIG. 24 according to an embodiment;

FIG. 27 is a perspective view of a left (port) side turbine fan airless tire design mounted on a turbine fan rim wherein the airless tire's tread has been made transparent allowing the turbine fan vanes to be viewed according to an alternative embodiment;

FIG. 28 is a perspective view of a right (starboard) side turbine fan airless tire design mounted on a turbine fan rim wherein the airless tire's tread has been made transparent allowing the turbine fan vanes to be viewed according to an alternative embodiment;

FIG. 29 is a perspective view of a left (port) side turbine fan airless tire design (as shown in FIG. 27) configured to be mounted on a turbine fan rim wherein the airless tire's tread has been made transparent allowing the turbine fan vanes to be viewed according to an alternative embodiment; and

FIG. 30 is a perspective view of a right (starboard) side turbine fan airless tire design (as shown in FIG. 28) configured to be mounted on a turbine fan rim wherein the airless tire's tread has been made transparent allowing the turbine fan vanes to be viewed according to an alternative embodiment.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Reference will now be made in detail to the presently preferred embodiments of the present turbine fan rims, hubcaps and airless tires and the systems comprising these devices, examples of which are illustrated in the accompanying drawings, wherein like reference numerals refer to like elements throughout.

The present turbine fan rims, turbine fan hubcaps and turbine fan airless tires can increase traction by creating a downward force on a vehicle when turned in a clockwise direction on the right (starboard) side of the vehicle and counter-clockwise on the left (port) side of the vehicle relative to the forward direction of the vehicle. This increased traction can be achieved without requiring the addition of materials and structures to a vehicle's body, such as spoilers, which are commonly used to create down force and to increase traction. Like spoilers and air dams, the present turbine fan rims, turbine fan hubcaps and turbine fan airless tires can increase down force as the speed of the vehicle increases, which is when additional traction is needed most. Specifically, the present turbine fan rims, turbine fan hubcaps and turbine fan airless tires can comprise spokes or similar structures configured to act as turbine vanes capable of producing significant airflow in a particular direction. These turbine fan rim vanes can be angled and deployed so that air is drawn from under the vehicle and moved away from the vehicle through each rim, hubcap and/or airless tire. By drawing air from under the vehicle, a partial vacuum can be generated pulling the vehicle body downward toward the ground, thus increasing traction while also lowering the vehicle's center of gravity which improves vehicle stability. The amount of air flow is dependent on the rotation of the wheels, hubcaps and airless tires, which is directly proportional to the speed at which the vehicle is travelling. Thus, at greater speeds, the partial vacuum created will also be greater increasing both traction and stability as the speed of the vehicle increases.

The number, size and angle of the vanes can be optimized for specific types of vehicles and specific purposes. Furthermore, the vanes can be either integral to the rim, hubcap or airless tire design or can be added to some existing rim or airless tire designs as an after-market add-on feature. The present turbine fan rims, turbine fan hubcaps and turbine fan airless tires can be comprised of alloys, steel, carbon fiber, plastics or other suitable materials or each can be used in conjunction with future technologies and materials, so long as the turbine fan vanes can be configured to draw air from under a vehicle's body when the rim, hubcap, or airless tire is rotated in a particular direction. A significant additional benefit of the present rim and tire designs is the cooling effect that the air flow created by these rims, hubcaps and airless tire designs can have on brake surfaces located near them.

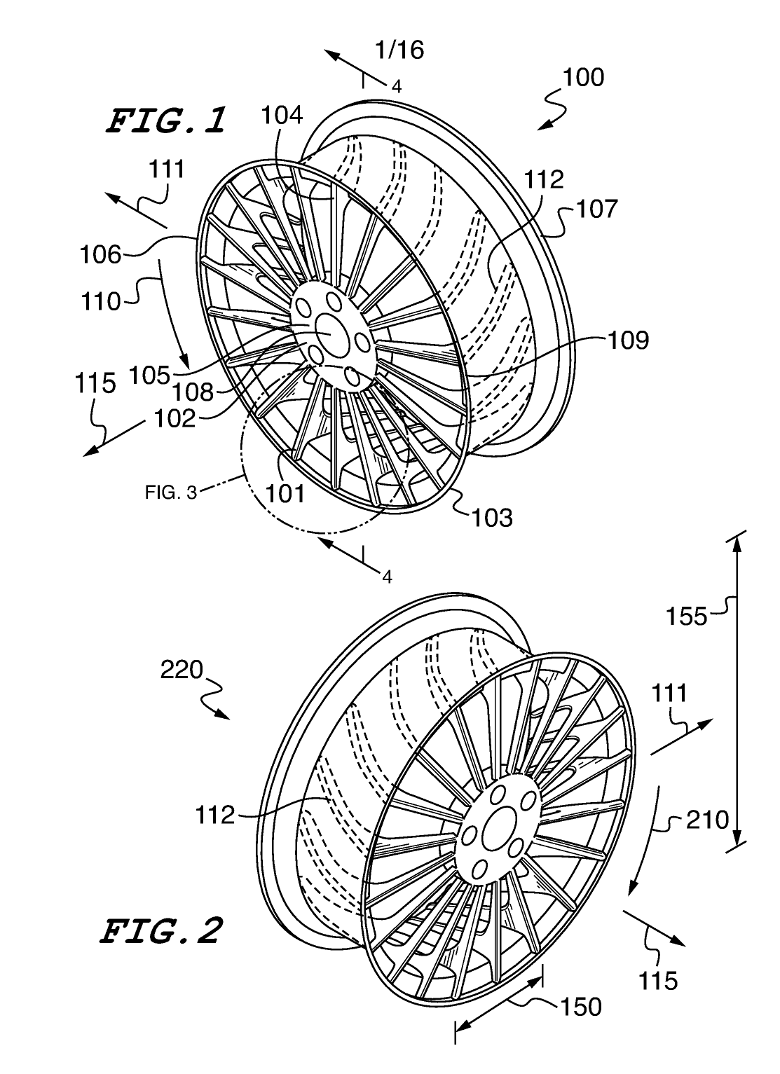

FIG. 1 is a perspective view of a turbine fan rim 100 configured for use on the left (port) side of a vehicle according to an embodiment. The turbine fan rim 100 can comprise one or more spokes or turbine fan rim vanes 101 configured to move air in a particular direction. In an embodiment, these turbine fan rim vanes 101 can be evenly spaced around the circumference of the turbine fan rim 100 and each turbine fan rim vane 101 can extend from a hub 102 to a rim 103. At the location where the turbine fan rim vane 101 connects to the hub 102, the outer surface of the spoke 104 can be located in a plane parallel to that of the outer surface of the hub 105. As the spoke or vane 101 extends to the rim 103 on the car side (starboard side) of the rim 107, each turbine fan rim vane 101 can comprise a curved or concave surface 112 that can extend from a curbside (port side) of the wheel 106 to a car side of the wheel 107, spanning most, if not the entire turbine fan rim 100 width, forming a sickle-shape. In an embodiment, at the location where the turbine fan rim vane 101 contacts the rim 103 at the curb side edge of the wheel 106, the front surface of the spoke 104 can be parallel to the front surface of the hub 105. The hub 102 can comprise a center bore 108 for mounting the rim turbine 100 onto a vehicle (not shown). The hub 102 can also comprise one or more bolt holes 109 for securing the rim turbine 100 onto a vehicle.

The turbine fan rim 100 can turn in a direction of wheel rotation 110 corresponding to the direction of vehicle travel 111 and can allow air to flow from beneath a vehicle in a particular direction 115. Air flow in this direction 115 can create a partial vacuum under the vehicle by reducing air pressure under the vehicle relative to that above the vehicle thus creating a downward force, which can also lower the vehicle's center of gravity, created by the weight of air under normal pressure located in a column above the vehicle.

FIG. 2 is a perspective view of a turbine fan rim 220 intended for use on the right (starboard) side of a vehicle according to an embodiment, The direction of the curved surface of the spokes 112 in a right side wheel 220 can be the non-superposable minor image of the curved surface 112 comprising the spokes 101 of the left side turbine fan rim 100 (shown in FIG. 1). The entire right side turbine fan rim 220 and the entire left side turbine fan rim 100 can be non-superposable mirror images of each other, as shown in FIGS. 1 and 2. This is necessary so that the turbine fan rims and/or turbine fan airless tires on each side of the car can move air, in opposite directions, and away from the underside of the vehicle when the vehicle is moving forward in direction 111. The right side turbine fan rim 220 can turn in a clockwise direction of wheel rotation 210 corresponding to a forward direction of vehicle travel 111 and can allow for the direction of air flow 115 from beneath a vehicle to away from a vehicle (not shown). The clockwise direction of wheel rotation 110 for a right side wheel 220 is opposite that of the left side wheel rotation (not shown). These opposite directions of wheel rotation 110 and 210 can allow for the desired direction of air flow 115, which is away from the vehicle. This direction of air flow 115 can create a partial vacuum under the vehicle allowing for increased traction and greater vehicle stability as discussed above.

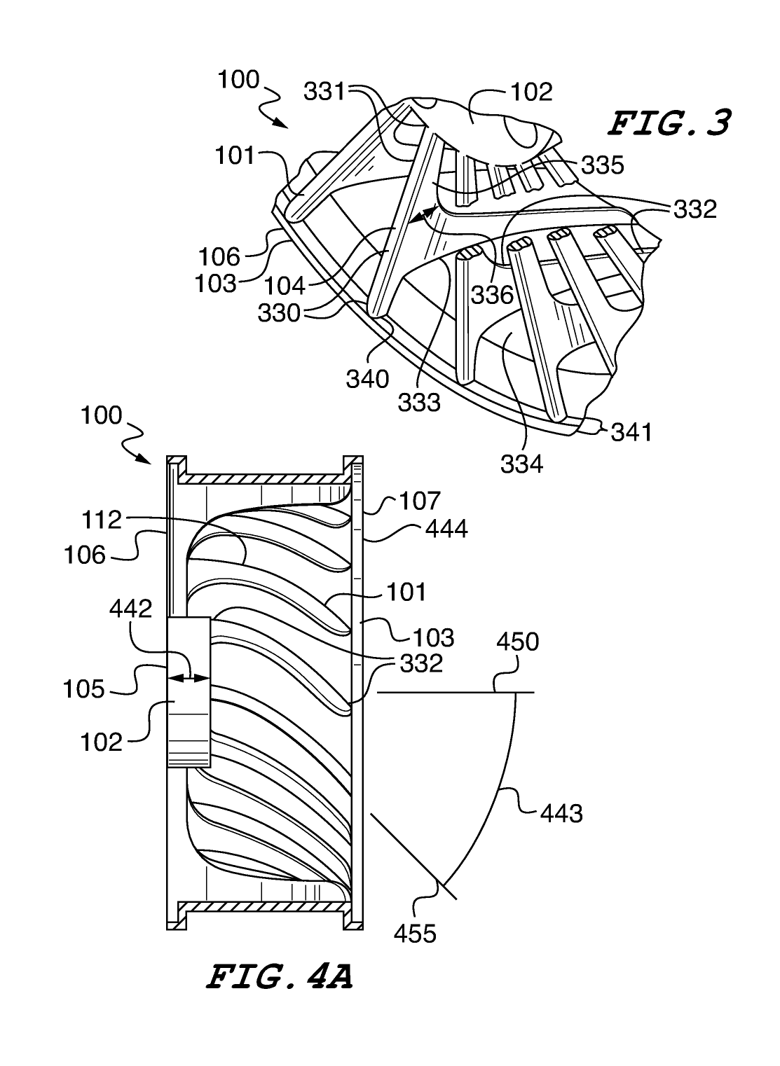

FIG. 3 is a magnified partial cross-sectional view of the left (port) side turbine fan rim shown in FIG. 1 according to an embodiment. As described above, the turbine fan rim 100 can comprise one or more turbine fan rim vanes 101, which can connect the hub 102 to the rim 103. In an embodiment, the hub 102 and turbine fan rim vanes 101 can have a positive offset with respect to the turbine fan rim vanes 101 connecting to the rim 103, preferably extending perpendicular to the rim 103 inward to connect to the hub 102. This positive offset can provide space behind and within the turbine fan rim 100 allowing for sufficient clearance for brakes, calipers and other brake components (not shown), which are typically located behind the rims of most vehicles. The turbine fan rim 100 can be made from materials having sufficient rigidity and tensile strength to maintain its structural integrity under normal use conditions. Such materials can include one or more metals, polymers, ceramics, or other suitable materials or combinations of such materials.

In an embodiment, each turbine fan rim vane 101 can comprise a rim end 330, a hub end 331 and a vane extension 332. The front surface of the turbine fan rim vane 101 can comprise both the rim end 330 and the hub end 331. According to an embodiment the rim end 330 can connect at its lowest point to the inner rim surface 334 or at an inner flange surface 340 and the vane extension 332 can comprise a width sufficient to extend across the entire width of the inner rim surface 334. In an embodiment, the spoke 333 can be connected to the inner rim surface 334 across the entire width of the rim 103 or at various points along the inner rim surface 334.

In an embodiment, the hub end of each spoke 331 can connect to the hub 102. As the spoke extends from the hub 102 towards the inner rim surface 334, a width of the hub end 336, defined as the distance between the front surface of the turbine fan rim vane 104 and the inner side of the spoke 335, can increase. The width of the hub end 336 can be maximized in order to also maximize vane efficiency, but must not be so wide as to leave insufficient clearance for other components located near the wheel, such as axle components and brake components (not shown). In an embodiment, turbine fan rim vane width 336 can increase exponentially from approximately one-half (½) inch near the hub 102 to two and one half (2½) inches or more near the inner rim surface 334, resulting in the vane extension 332 having a desired shape. A desired shape is any shape that is capable of moving air from under a vehicle when the turbine fan rim 100 is rotated in a particular direction.

In an embodiment, the vane extension 332 can extend from the curbside edge 106 to the car side edge 107 of the turbine fan rim 100. However, the vane extension 332 can extend any distance across the inner rim surface 334, from the curbside edge 106 to the car side edge 107 that creates sufficient air movement. The vane extension 332 can even extend beyond the plane of the car side edge 107 of the inner rim surface 334 of the rim 103 so long as any part of the vane extension 332 located beyond the car side edge 107 of the rim 103 remains contained within the vehicle's body (not shown) and would not cause damage to the vehicle's body. Additionally, testing can be performed to optimize the length of each vane extension 332 based upon the amount of vacuum and traction that is desired for different vehicles and different driving purposes. In an embodiment, the width between the outer side 333 and inner side 335 of the vane extension 332 can vary from the curbside edge 106 to the car side edge 107 with the greatest width being located near the curbside edge 106 as the vane extension transitions to the rim end 330 and the hub end 331 of the turbine fan rim vane 101 according to an embodiment. In an embodiment, the line comprising the outer side 333 and the line comprising the inner side 335 of the vane extension 332 can be roughly parallel to each other. The distance between the inner side 335 and the outer side 333 of the vane extension 332 can define a turbine fan rim vane surface area that can be configured to create the amount of air flow that is desired at a particular rotational velocity. Greater air movement can be achieved by increasing the distances between the outer side 333 and the inner side 335 and the turbine fan rim vane surface area. The maximum distance between the inner side 335 and the outer side 333 of the tubine fan rim vane 101 in the vane extension 332 can be determined by the location of the brakes and other car components (not shown) located near the wheel or tire. The inner side of the turbine fan rim vane 335 must be configured so as not to interfere with the braking apparatus or any other part of the car's structure. The minimum distance can be any distance sufficient to provide some air movement from under the vehicle (not shown).

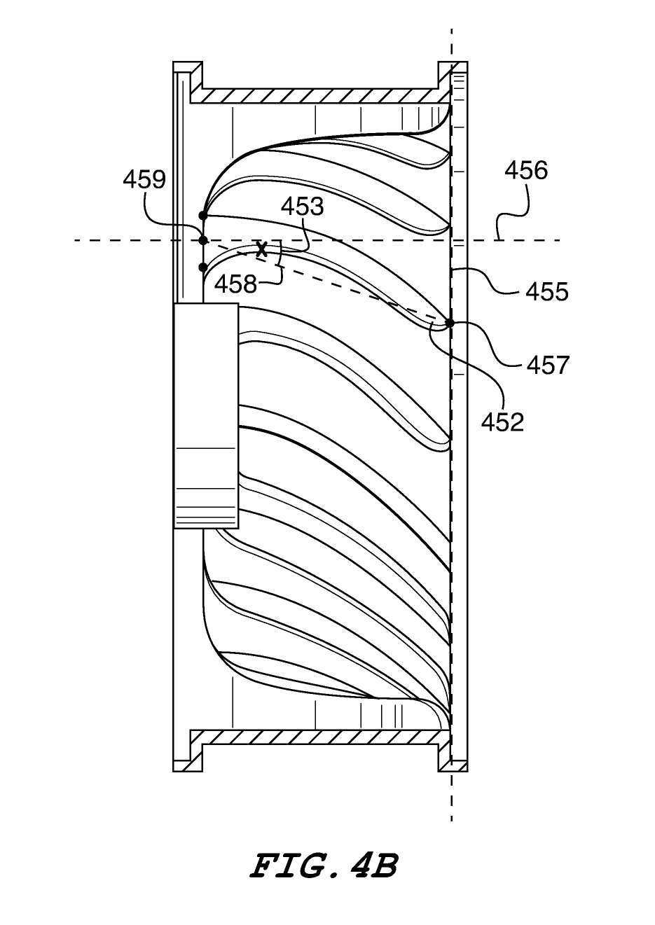

FIG. 4A is a cross sectional top view of an inside of a left side turbine fan rim 100 as shown in FIG. 1 according to an embodiment. The turbine fan rim 100 can comprise the hub 102 and the rim 103, as well as one or more turbine fan rim vanes 101, wherein each turbine fan rim vane 101 comprises the rim end (not shown), the hub end (not shown) and the vane extension 332. However, the thickness of the hub end 331 can be any thickness of the hub 442, including the being equal to the thickness of the hub 442, or thicker than the hub 102. The minimum thickness of the hub end 336 of the turbine fan rim vane 101 would be material-dependent and relate to the minimum thickness required to provide sufficient strength and rigidity for normal vehicle use. The maximum thickness of the hub end 336 of the turbine fan rim vane 101 can be limited by the other components of the car, such as brake components (not shown) located nearby. As permitted by the other car components located near the turbine fan rim 100, the thickness increases and becomes the vane extension of the turbine fan rim vane 332.

In an embodiment, the vane extension 332 of the turbine fan rim vane 101 extends from the curbside edge 106 of the turbine fan rim 100 to the car side edge 107 of the turbine fan rim 100. In an embodiment, the curb side edge 106 the vane extension 332 can be roughly perpendicular to the front hub surface 105. Near the car side edge 107, the vane extension 332 can be at or near a forty-five (45) degree angle 443 with a plane comprising the car side edge 107 of the rim 444. The angles between the vane extension 332 and the plane of the car side edge 107 of the turbine fan rim can comprise any angle 443 that is less than ninety (90) degrees to any angle greater than zero (0) degrees, as any angle within this range can produce air movement from under the vehicle (not shown).

Between the curbside edge 106 and the car side edge 107, the vane extension 332 can be curved to create desired angles. The curved surface of the turbine fan rim vane 112 can comprise a lesser degree of curvature near the car side edge 107 and a greater degree of curvature near the curbside edge 106. However, any transition for the curved surface 112 of the vane extension 332, including a straight line without any curve, will produce similar air movement and is contemplated as being encompassed by the present device. In an embodiment, the curvature of the vane extension 332 of the right side wheel 220 (shown in FIG. 2) and the curvature of the vane extension 332 of the left side rim turbine 100 (shown in FIG. 1) are non-superposable mirror images of each other.

FIG. 4B is a cross sectional top view of an inside of a left side turbine fan rim 100 as shown in FIG. 1 according to an embodiment. An acute angle 453 can be formed between the intersection of a first line 456 orthogonal to a plane 455 defined by the extension end 452 passing through the left midpoint 459 of the turbine fan rim vane 101 and a second line 458 connecting the left midpoint 459 of the turbine fan rim vane 101 and a right point 457 of the turbine fan rim vane 101 according to an embodiment.

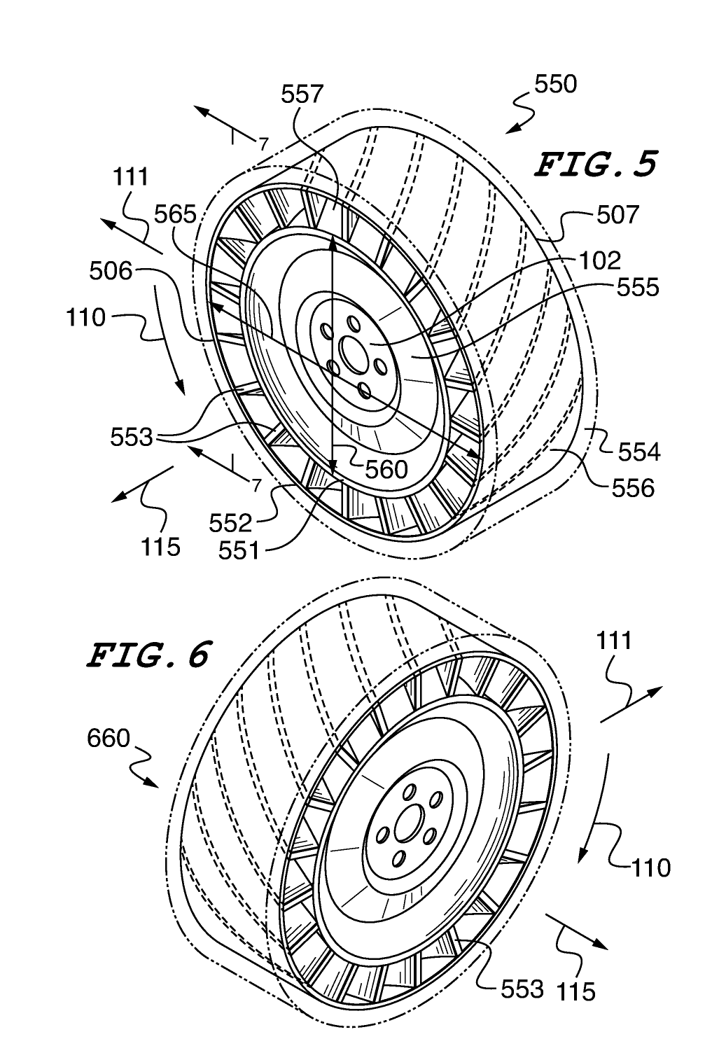

FIG. 5 is a perspective view of a turbine fan airless tire 550 intended for use on the left side of a vehicle (not shown) mounted on a standard rim 555, according to an embodiment. In an embodiment, a turbine fan airless tire 550 can comprise an inner band 551, an outer band 552, at least one turbine fan airless tire vane 553 and tread 554. The turbine fan airless tire 550 can comprise an inner band 551 comprising an outer surface 557 and a first diameter 560 and an outer band 552 comprising an inner surface (not shown) and an outer surface 556 as well as a curbside edge 506 and a car side edge 507 and a second diameter 565 wherein the second diameter 565 of the outer band 552 is greater than the first diameter 560 of the inner band 551 and wherein the outer band 552 is located circumferentially about the inner band 551. The tread 554 can be connected to the outer surface 556 of the outer band 552 or be an integral part of the outer band 552. The outer band 552 can be connected through the use of at least one turbine fan airless tire vane 553 to the outer surface 557 of the inner band 551. The inner band 551 can be used to attach the turbine fan airless tire 550 to a standard rim 555 or to a vehicle directly in some embodiments (not shown). The diameter of the inner band 551 can vary greatly. The minimum diameter for the inner band 551 can be configured to fit the size of the standard rim 555, if no rim 555 is present and the tire 550 can be directly attached to the vehicle. The outer diameter (first diameter) of the inner band 551 will be smaller than the inner diameter (second diameter) for the outer band 552, but these diameters can be adjusted to provide turbine fan airless tire vanes 553 of any desired width. In an embodiment, the minimum outer diameter 565 of the outer band 552 can be the smallest diameter at which a pneumatic tire can properly function within the wheel well of the vehicle (not shown). Likewise, in an embodiment, the maximum outer diameter 565 of the outer band 552, including the thickness of the tread 554, can be the largest diameter that will allow the tire 550 to move freely when turned within the wheel well of the vehicle. The difference between the diameter of the inner band 551 and the diameter of the outer band 552 can be that which allows sufficient air to be drawn from under the vehicle and pass through the turbine fan airless tire 550 to the curbside edge 506 of the turbine fan airless tire 550. The outer band 552 and the inner band 551 can have the same width or different widths depending upon the design of the turbine fan airless tire.

In an embodiment, the turbine fan airless tire vanes 553 can be located between the inner band 551 and the outer band 552, their width can be equal to the difference between the diameter of the outer band 552 and the diameter of the inner band 551. The turbine fan airless tire vanes 553 can extend from the curbside edge 506 to the car side edge 507 of the inner band 551 and outer band 552.

In an embodiment, each turbine fan airless tire vane 553 can be identical in its configuration to the other turbine fan airless tire vanes 553 and multiple turbine fan airless tire vanes 553 can be evenly spaced radially about the circumference of the turbine fan airless tire inner band 551. The left side turbine fan airless tire 550 can turn in a counter-clockwise direction of tire rotation 110 based on a forward direction of vehicle travel 111 and can create the direction of air flow 115 away from the vehicle. This direction of air flow 115 can create a partial vacuum under the vehicle and can allow for increased traction of the vehicle with a surface below (not shown).

FIG. 6 is a perspective view of a turbine fan airless tire 660 intended for use on the right side of a vehicle according to an embodiment. The direction of the turbine fan airless tire vanes 553 in a right side tire 660 form a non-superposeable mirror image of the turbine fan airless tire vanes 553 comprising the left side turbine fan airless tire 550 in FIG. 5. The right side tire 660 can turn in a clockwise direction of tire rotation 110 corresponding to the direction of vehicle travel 111 and can allow for the direction of air flow 115 from beneath a vehicle to away from a vehicle (not shown). The reversal of the vane direction allows for the direction of air flow in relation to the car created by both tires to be away from the center of the vehicle. As discussed above, air flow 115 in this direction can create a partial vacuum under the vehicle.

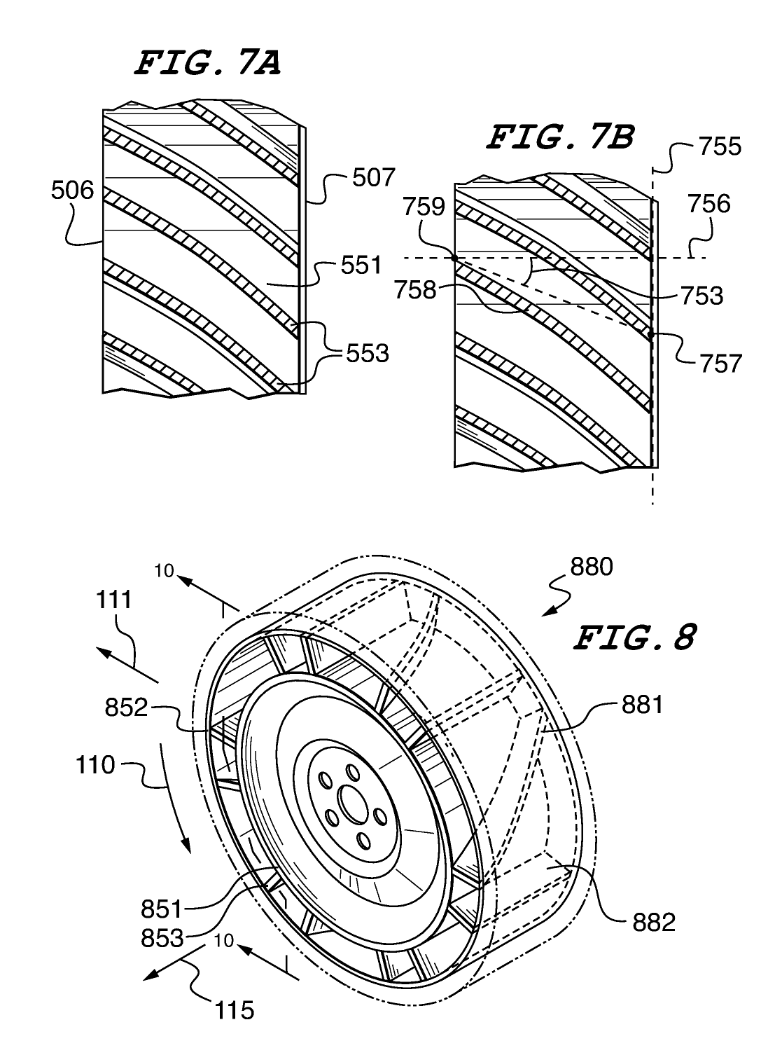

FIG. 7A is a cross sectional view of the left (port) side turbine fan airless tire design as shown in FIG. 5 according to an embodiment. A turbine fan airless tire 550 can comprise one or more turbine fan airless tire vanes 553 located between an inner band 551 an outer band (not shown). In an embodiment, one or more turbine fan airless tire vanes 553 can be curved and can extend from the curbside edge 506 of the inner band 551 and the outer band 552 to the car side edge 507 of the inner band 551 and the outer band 552. The turbine fan airless tire vanes 553 can extend the entire width of the bands 551 and 552 in order to maximize airflow. It is also contemplated that the turbine fan airless tire vanes 553 can extend past the edges of the bands 551 and 552 on the car side 507 of the tire. Turbine fan airless tire vanes 553 of any size suitable to create air movement can be used so long as these vanes 553 do not interfere with vehicle's normal operation.

In an embodiment, each turbine fan airless tire vane 553 can form an approximate forty-five (45) degree angle with the plane of the car side edge 507 of either or both of the bands 551 and 552. The angle formed between the turbine fan airless tire vanes 553 and the car side edge 507 can be varied to adjust air flow. The angle formed between the turbine fan airless tire vanes 553 and the curbside 506 of the bands 551 and 552 can be closer to ninety (90) degrees in some embodiments. In an embodiment, one or more turbine fan airless tire vanes 553 can curve smoothly between the curbside edge 506 and the car side edge 507. However, the turbine fan airless tire vanes 553 can also be straight or be of any shape capable of creating air movement from under a vehicle when rotated in a particular direction. Additionally, the number and spacing of the turbine fan airless tire vanes 553 can be varied to achieve optimal air flow.

FIG. 7B is a cross sectional view of the left (port) side turbine fan airless tire design as shown in FIG. 5 according to an embodiment. An acute angle 753 can be formed between the intersection of a first line 756 orthogonal to a plane 755 defined by the extension end 752 passing through the left midpoint 759 of the turbine fan airless tire vane 553 and a second line 758 connecting the left midpoint 759 of the turbine fan airless tire vane 553 and a right point 757 of the turbine fan airless tire vane 553 according to an embodiment.

FIG. 8 is a perspective view of an alternate embodiment of a turbine fan airless tire 880 intended for use on the left side of a vehicle (not shown) wherein the outer band of the tire is shown as being transparent according to an alternative embodiment. The airless tire 880 depicts and alternative pattern of turbine fan airless tire vane 553 positioning between the inner band 551 and the outer band 552. In this embodiment, angled vanes 881 can be positioned at angles similar to the turbine fan rim vanes 553 depicted and described in FIG. 7. However, located between or among these angled turbine fan airless tire vanes 881, can be straight turbine fan airless tire vanes 882, or vanes that are positioned at angles that are different from the angle created by the angled turbine fan airless tire vanes 881. These straight turbine fan airless tire vanes 882 can provide additional stability for the turbine fan airless tire 880. As with the angled turbine fan rim vanes 553 shown in FIGS. 5, 6 and 7, the angled turbine fan airless tire vanes 881 of the airless tire 880, shown in this alternative embodiment, can create air flow 115 away from the center of the vehicle as tire rotation 110 occurs when the vehicle moves in a forward direction of vehicle travel 111 creating a partial vacuum under the vehicle and improving traction and stability.

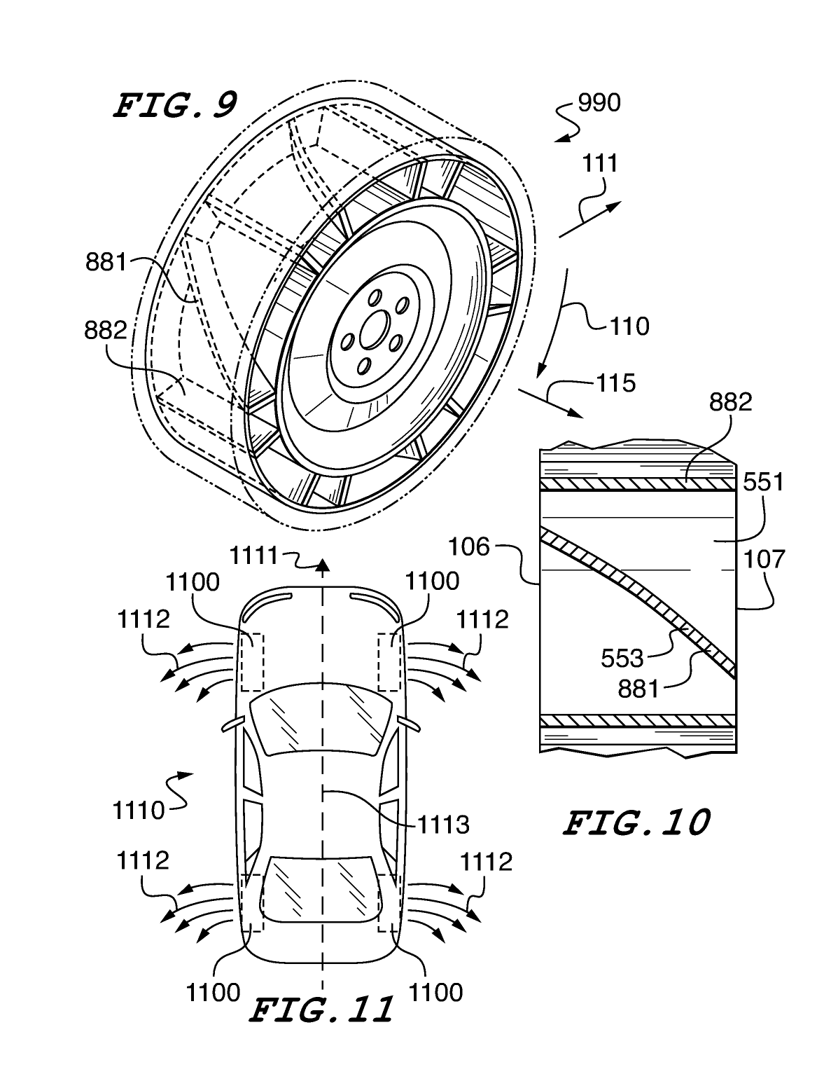

FIG. 9 is a perspective view of an alternative embodiment of a turbine fan airless tire 990 intended for use on the right side of a vehicle (not shown) wherein the outer band of the tire is shown as being transparent according to an embodiment. The direction of the angled vanes 881 in a right side turbine fan airless tire 990 can be in the non-superposable mirror image of the angled turbine fan airless tire vanes 881 comprising the driver side wheel 880 in FIG. 8. The passenger side turbine fan airless tire 990 can turn in a direction of tire rotation 110 corresponding to the direction of vehicle travel 111 while still allowing for the direction of air flow 115 from beneath a vehicle to away from a vehicle's center (not shown). The clockwise direction of wheel rotation 110 for a right side turbine fan airless tire 990 is opposite that of the counter-clockwise left side wheel rotation shown in FIG. 8. The reversal of the angled vane 881 direction allows for the direction of air flow 115 created by these tires to both be away from the vehicle's center as the vehicle moves forward.

FIG. 10 is a cross-sectional view of a turbine fan airless tire 880 as shown in FIG. 8 according to an alternative embodiment. A turbine fan airless tire 880 can comprise one or more vanes 853 located between an inner band 851 and an outer band 852. The turbine fan airless tire vanes 853 can be either angled turbine fan airless tire vanes 881 or straight turbine fan airless tire vanes 882 and each can extend from an curbside 506 of the inner band 851 and the outer band 852 to the car side 507 of the inner band 851 and the outer band 852. Each turbine fan airless tire vane 853 can be located at a distance from each turbine fan airless tire vane 853 sufficient to maximize air flow 115 away from the vehicle (not shown).

FIG. 11 is a top view of a vehicle 1110 comprising the present turbine fan rims, turbine fan airless tires, and/or turbine fan hubcaps 1100 which are shown to be creating air movement 1112 from beneath the vehicle 1110 when the vehicle 1110 travels in a forward direction of travel 1111 according to an embodiment. A vehicle 1110 can comprise one or more turbine fan airless tires, turbine fan hubcaps or turbine fan rims 1100, which are rotatably connected to the vehicle 1110. The inner hubs or inner bands and the outer rims or outer hubs of the turbine fan rims, turbine fan hubcaps, or turbine fan airless tires can be rotated in a first direction 110, 210, etc., which can cause air located under the underside of the vehicle 1110 to be removed from under the underside of the vehicle 1110. When the turbine fan airless tires, hubcaps or rims 1100 are rotated to create forward movement 1111 of the vehicle, air located under the vehicle 1110 can flow in a direction 1112 away from the vehicle's central axis 1113. This air flow in direction 1112 can create a partial vacuum under the vehicle 1110 resulting in a down force, which can both improve traction and lower the vehicle's center of gravity. Although a vehicle is shown that is using four turbine fan wheels, hubcaps and/or airless tires, the use of only one or two turbine fan wheels, hubcaps and/or airless tires could also be effective in improving a vehicle's traction and lowering its center of gravity.

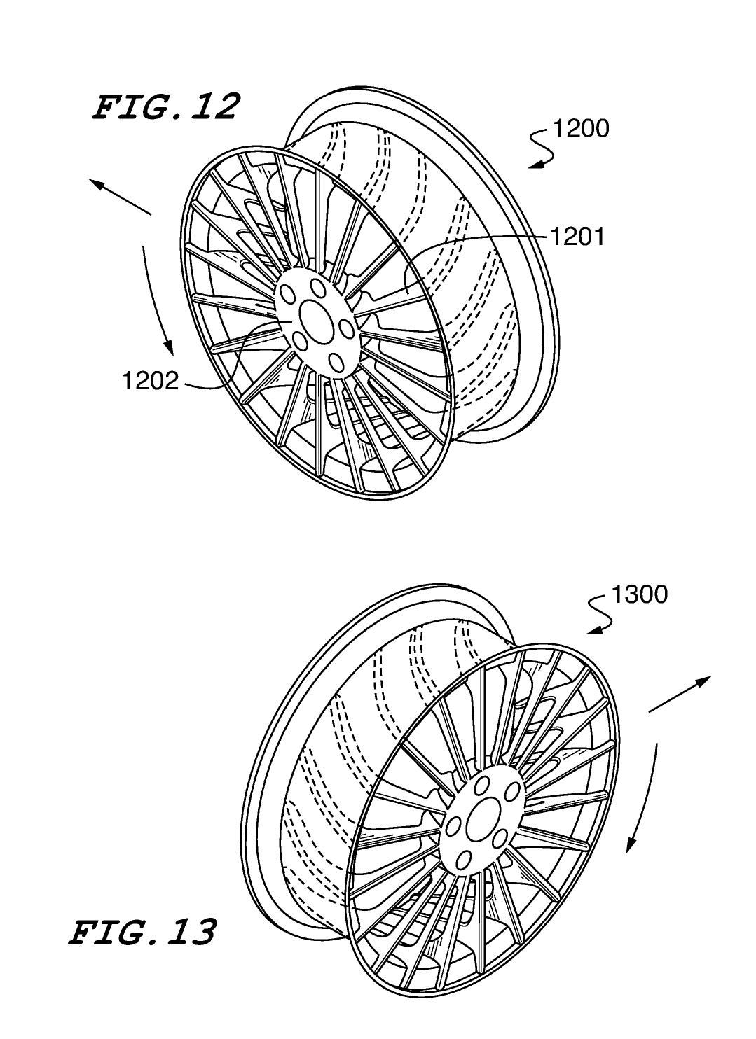

FIG. 12 is a perspective view of a left (port) side turbine fan rim design 1200 according to a first alternative embodiment. This design is similar to the design 100 shown in FIG. 1 except the turbine fan vanes 1201 are connected to the hub 1202 at an angle which is not in the same plane as the outer surface of the hub 1202.

FIG. 13 is a perspective view of a right (starboard) side turbine fan rim design 1300 according to a first alternative embodiment. This turbine fan rim design 1300 is the non-superposable minor image of turbine fan rim design 1200.

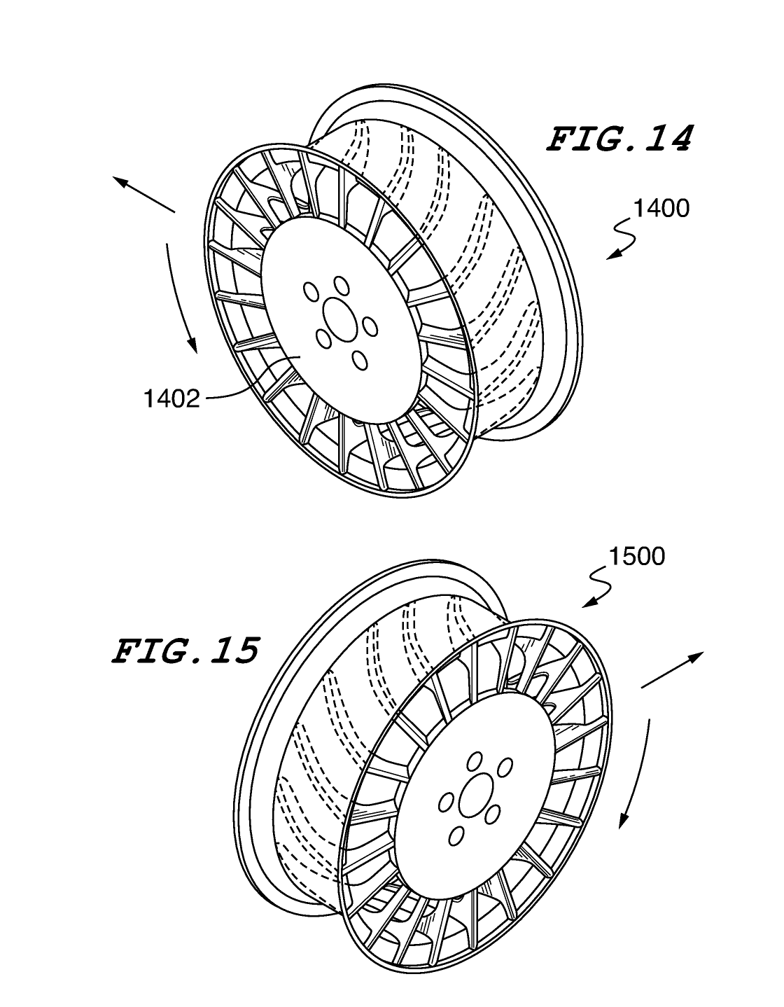

FIG. 14 is a perspective view of a left (port) side turbine fan rim design 1400 according to a second alternative embodiment. This embodiment is very similar to the embodiment shown in FIG. 1 (100) except the hub 1402 has a diameter that is significantly larger than the hub 102 shown in FIG. 1.

FIG. 15 is a perspective view of a right (starboard) side turbine fan rim design 1500 according to a second alternative embodiment. This turbine fan rim design 1500 is the non-superposable minor image of turbine fan rim design 1400.

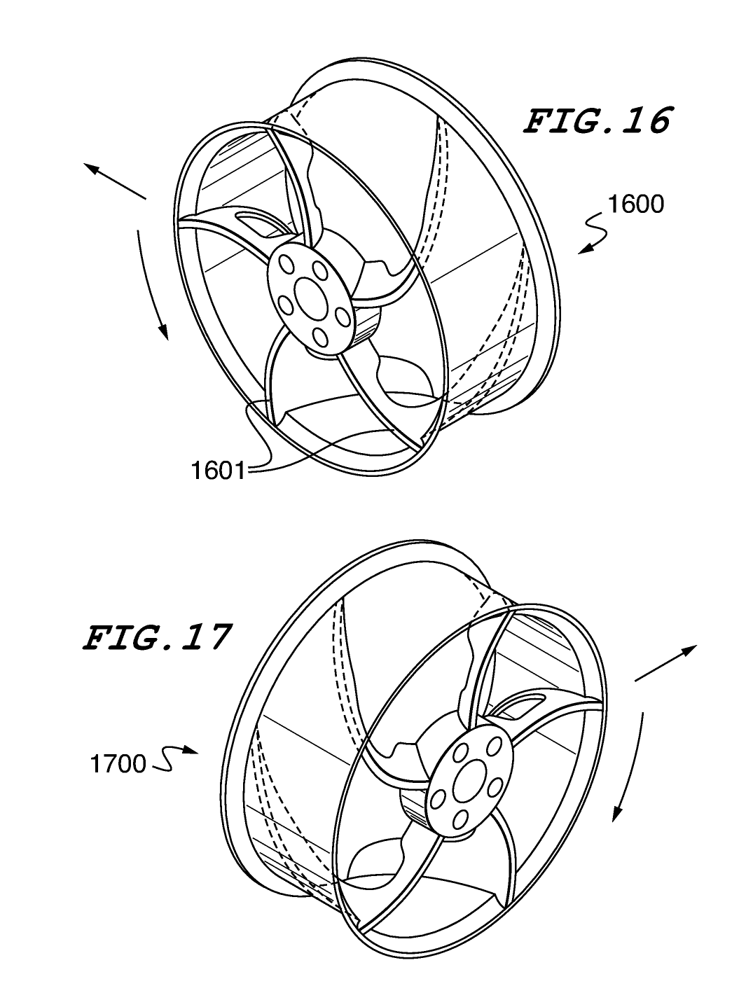

FIG. 16 is a perspective view of a left (port) side turbine fan rim design 1600 according to a third alternative embodiment. This turbine fan rim design 1600 comprises only five turbine fan rim vanes 1601. The use of fewer turbine fan rim vanes 1601 per rim allows each turbine fan rim vane 1601 to be placed further apart, which allows each turbine fan rim vane 1601 to be wider and have a more sweeping angle.

FIG. 17 is a perspective view of a right (starboard) side turbine fan rim design 1700 according to a third alternative embodiment, which is the non-superposable minor image of turbine fan rim design 1600.

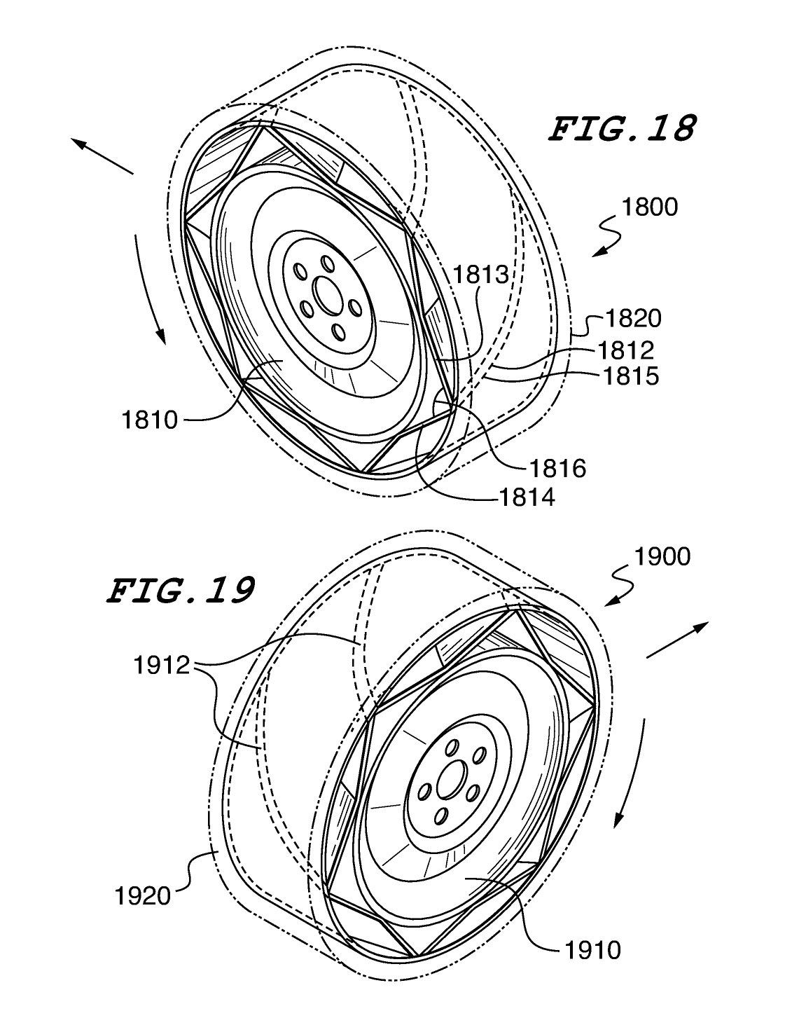

FIG. 18 is a perspective view of a left (port) side turbine fan airless tire design 1800 mounted on a standard rim 1810 wherein the airless tire's tread 1820 has been made transparent allowing the turbine fan vanes 1812 to be viewed according to a first alternative embodiment. In this embodiment, each turbine fan airless tire vane 1812 is formed by a first vane section 1813 and a second vane section 1814, which meet at a vane peak 1815 and form a vane angle 1816.

FIG. 19 is a perspective view of a right (starboard) side turbine fan airless tire design 1900, which is the non-superposable mirror image of turbine fan rim design 1800, mounted on a standard wheel rim 1910 wherein the airless tire's tread 1920 has been made transparent allowing the turbine fan vanes 1912 to be viewed according to a first alternative embodiment.

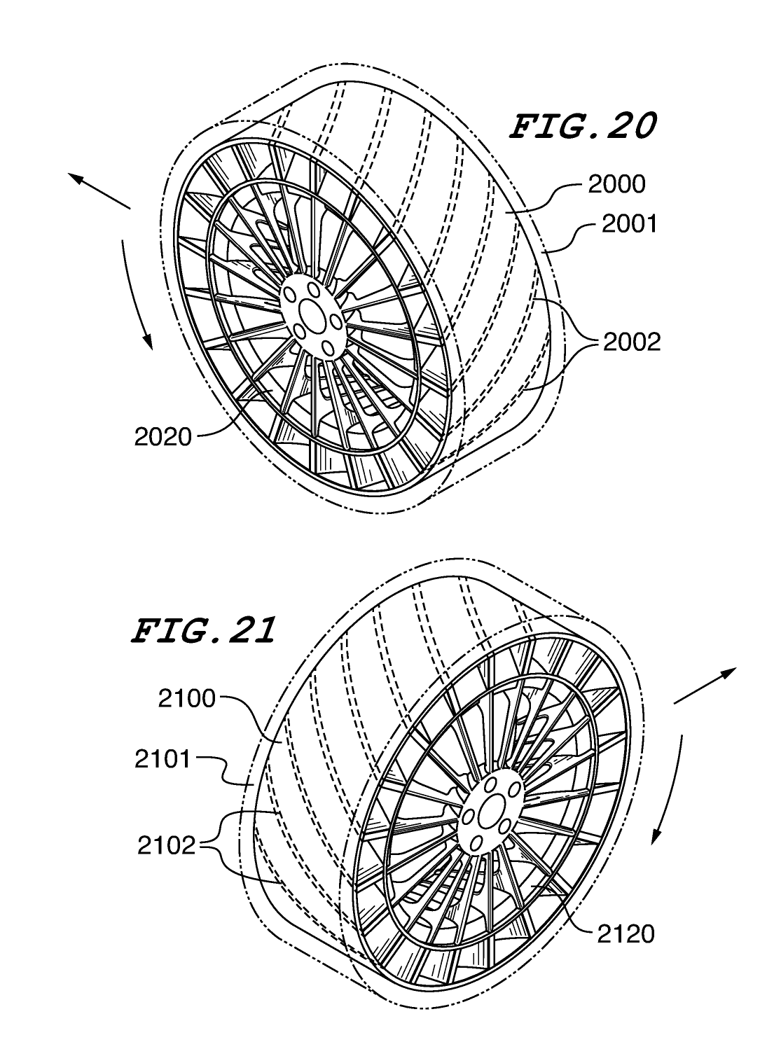

FIG. 20 is a perspective view of a left (port) side turbine fan airless tire design 2000, identical to that shown in FIG. 5, mounted on a turbine fan rim 2020, identical to that shown in FIG. 1, wherein the airless tire's tread 2001 has been made transparent allowing the turbine fan vanes 2002 to be viewed according to an embodiment. As discussed above, airflow can be maximized by using both a turbine fan airless tire 2000 and a turbine fan rim 2020 together on each wheel. In order to achieve airflow in the desired direction, away from the underside of the vehicle, port side turbine fan airless tires and a port side turbine rims should be used together and a starboard side turbine fan airless tires and a starboard side turbine rims should be used together. A port side turbine fan airless tire mounted on a starboard side turbine rim or a similar combination would result in reduced airflow because the tire and the rim would move air in opposite directions when both were rotated in the same direction.

FIG. 21 is a perspective view of a right (starboard) side turbine fan airless tire design 2100, identical to that shown in FIG. 6, mounted on a turbine fan rim 2120, identical to that shown in FIG. 2, wherein the airless tire's tread 2101 has been made transparent allowing the turbine fan vanes 2102 to be viewed according to an embodiment. This tire and rim configuration is the non-superposable mirror image of the turbine fan airless tire design 2000 and the turbine fan rim 2020 shown in FIG. 20.

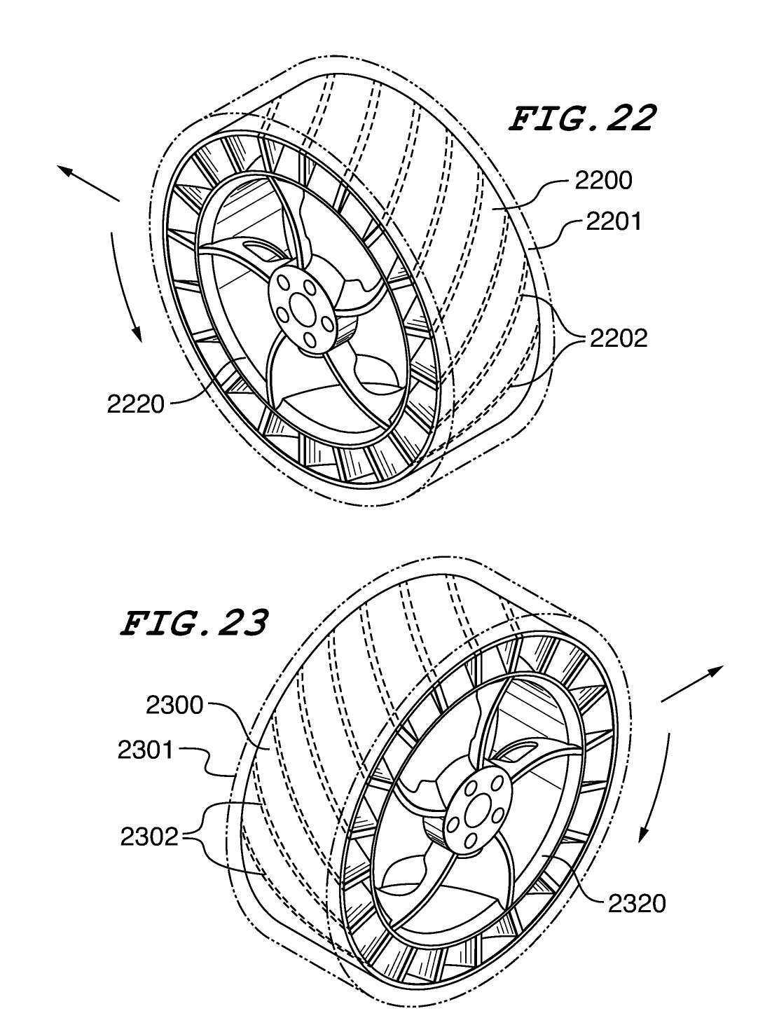

FIG. 22 is a perspective view of a left (port) side turbine fan airless tire design 2200, identical to that shown in FIG. 5, mounted on a turbine fan rim 2220, identical to that shown in FIG. 16, wherein the airless tire's tread 2201 has been made transparent allowing the turbine fan vanes 2202 to be viewed according to an alternative embodiment.

FIG. 23 is a perspective view of a right (starboard) side turbine fan airless tire design 2300, identical to that shown in FIG. 6, mounted on a turbine fan rim 2320, identical to that shown in FIG. 17, wherein the airless tire's tread 2301 has been made transparent allowing the turbine fan vanes 2302 to be viewed according to an alternative embodiment. This tire and rim configuration is the non-superposable mirror image of that shown in FIG. 22.

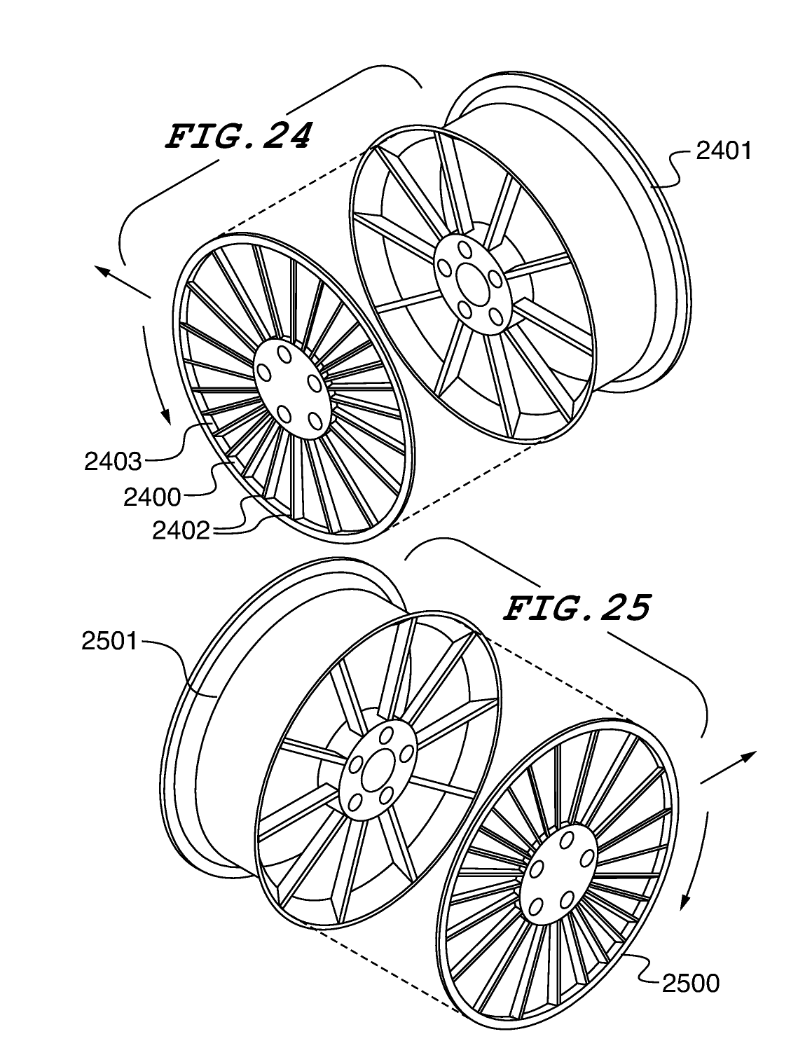

FIG. 24 is a perspective view of a left (port) side turbine fan hubcap design 2400 configured to be mounted on a standard rim 2401 according to an embodiment. Although hubcaps are typically much thinner than rims, hubcaps can be designed to create airflow just as the turbine fan rims described above. The turbine fan hubcap 2400 can comprise one or more turbine fan hubcap vanes 2402, which can be positioned at an acute angle, or comprise a shape configured to create airflow in a particular direction. Similar to the turbine fan rims and turbine fan airless tires described above, each turbine fan hub cap 2400 can be paired with its non-superposable mirror image turbine fan hubcap installed on the wheel located on the opposite side of the vehicle so that each moves air from under the vehicle when rotated in a particular direction. The airflow created by the turbine fan hubcap 2400 can also be useful in cooling brake surfaces located in the path of the airflow created.

FIG. 25 is a perspective view of a right (starboard) side turbine fan hubcap design 2500 configured to be mounted on a standard rim 2501, according to an embodiment, which is the non-superposable minor image of turbine fan hub cap 2400 shown in FIG. 23.

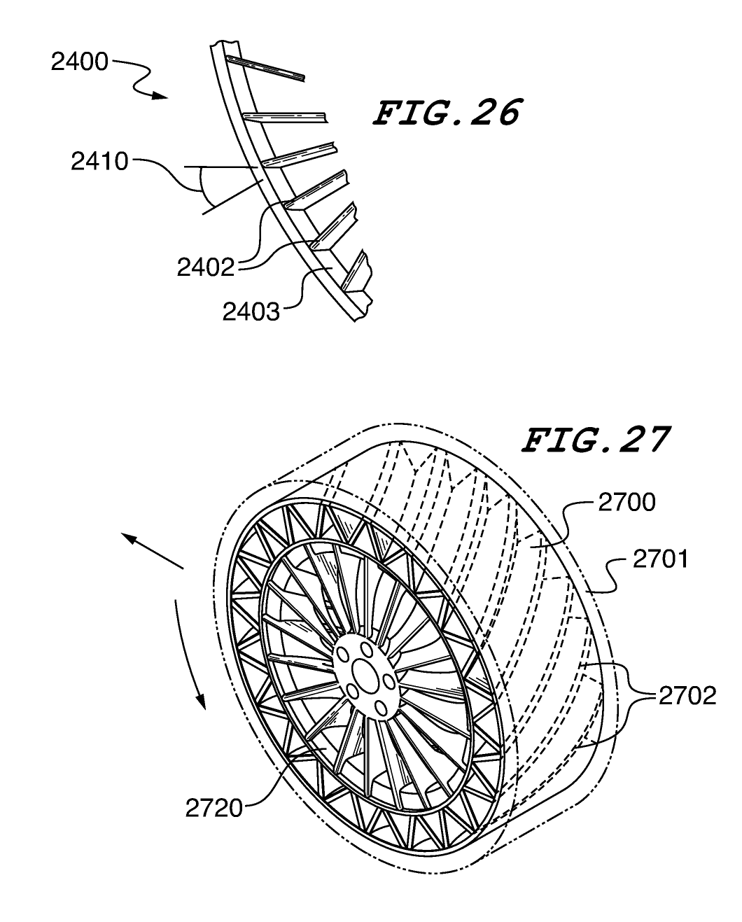

FIG. 26 is a partial cross sectional perspective view of the front of a left (port) side turbine fan hubcap design 2400 shown in FIG. 24 according to an embodiment. In this figure, the acute angle 2410 of each turbine fan hubcap vane 2402 in relation to the hubcap rim 2403 can be more easily be viewed.

FIG. 27 is a perspective view of a left (port) side turbine fan airless tire design 2700 mounted on a turbine fan rim 2701, identical to that shown in FIG. 1, wherein the airless tire's tread 2701 has been made transparent allowing the turbine fan airless tire vanes 2702 to be viewed according to an alternative embodiment. The airless tire design 2700 shown in this figure is similar to the design 1820 shown in FIG. 18 except that design 2700 comprises many additional turbine fan airless tire vanes 2702 and the turbine fan airless tire vanes 2702 are comprised of triangular structures.

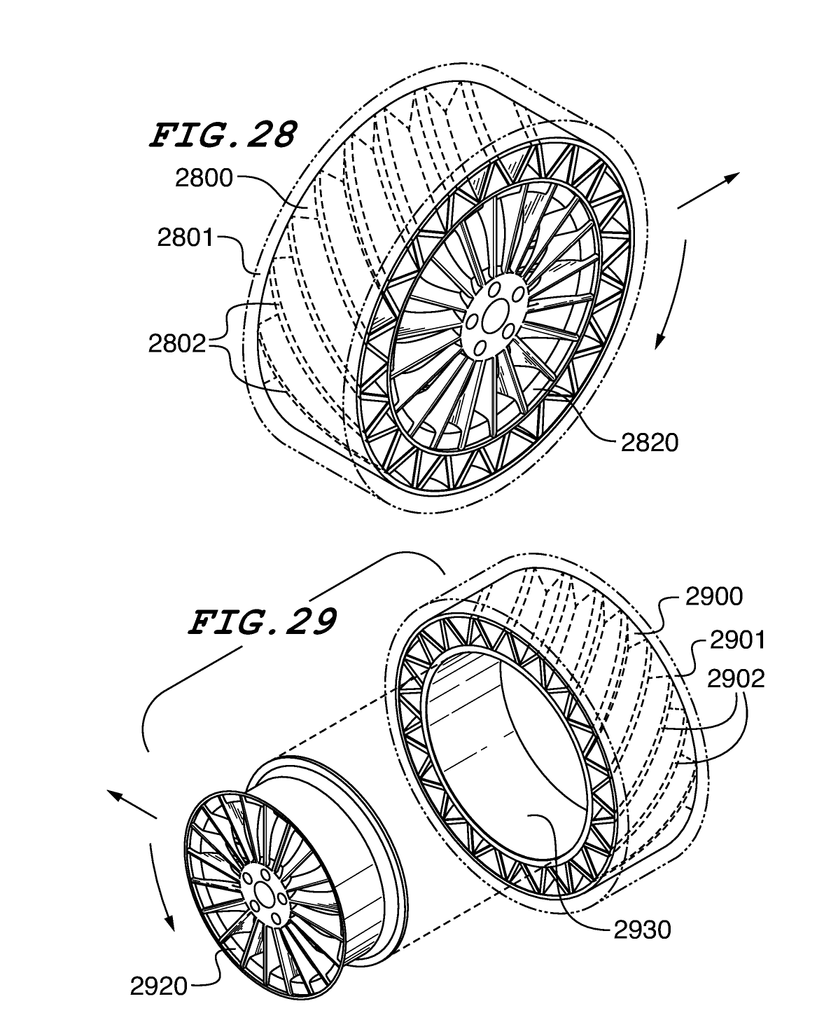

FIG. 28 is a perspective view of a right (starboard) side turbine fan airless tire design 2800 mounted on a turbine fan rim 2820, identical to that shown in FIG. 2, wherein the airless tire's tread 2801 has been made transparent allowing the turbine fan vanes 2802 to be viewed according to an alternative embodiment. This wheel configuration is the non-superposable minor image of turbine fan hub cap 2700 shown in FIG. 27.

FIG. 29 is a perspective view of a left (port) side turbine fan airless tire design 2900 (as shown in FIG. 27) configured to be mounted on a turbine fan rim 2920 wherein the airless tire's tread 2901 has been made transparent allowing the turbine fan vanes 2902 to be viewed according to an alternative embodiment, This view clearly shows that the turbine fan rim 2920 is distinct from, and can be removed from the turbine fan airless tire design 2900. This figure also shows the inner surface of the inner band 2930.

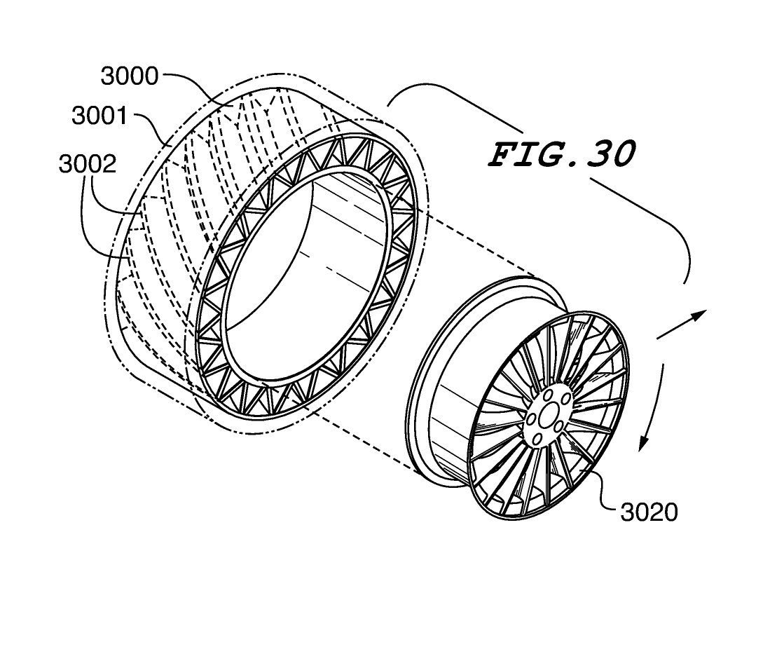

FIG. 30 is a perspective view of a right (starboard) side turbine fan airless tire design (as shown in FIG. 28) configured to be mounted on a turbine fan rim wherein the airless tire's tread has been made transparent allowing the turbine fan vanes to be viewed according to an alternative embodiment.

Although the present devices and method for their use have been described in terms of exemplary embodiments, they are not limited thereto. Rather, the appended claims should be construed broadly, to include other variants and embodiments of these devices, which may be made by those skilled in the art without departing from the scope and range of equivalents of these devices. However, any such variants would still result in the movement of air from under the vehicle, the result of which is a partial vacuum which improves traction and vehicle stability.

What is claimed is:

1. A turbine fan rim comprising:
an inner hub comprising an outer surface and a first diameter;
an outer rim comprising an inner surface as well as a curbside edge and a car side edge and a second diameter wherein the second diameter of the outer rim is greater than the first diameter of the inner hub and wherein the outer rim is located circumferentially about the inner hub; and
at least one turbine fan rim vane comprising a first end and a second end, wherein the first end of each turbine fan rim vane is connected to the outer surface of the inner hub and the second end of each turbine fan rim vane is connected to the inner surface of the outer rim and wherein at least one turbine fan rim vane is configured to move air in a particular direction when the inner hub and the outer rim are both rotated in a first direction.

2. The turbine fan rim as recited in claim 1, wherein at least one turbine fan rim vane comprises a curved shape.

3. The turbine fan rim as recited in claim 1, wherein at least one turbine fan rim vane comprises a sickle-shape and also comprises a vane extension.

4. The turbine fan rim as recited in claim 1, wherein an acute angle is formed between the intersection of a first line orthogonal to a plane defined by the extension end passing through the left midpoint of the turbine fan rim vane and a second line connecting the left midpoint of the turbine fan rim vane and a right point of the turbine fan rim vane.

5. A turbine fan rim as recited in claim 1, wherein the particular direction of air flow is generally toward the car side edge of the outer rim and generally away from the curbside edge of the outer rim.

6. A turbine fan rim as recited in claim 1, wherein the first direction is clockwise.

7. A turbine fan rim as recited in claim 1, wherein the first direction is counter-clockwise.

8. A turbine fan airless tire comprising:
an inner band comprising an inner surface and an outer surface and a first diameter;
an outer band comprising an inner surface and an outer surface as well as a curbside edge and a car side edge and a second diameter wherein the second diameter of the outer band is greater than the first diameter of the inner band and wherein the outer band is located circumferentially about the inner band; and
at least one turbine fan airless tire vane comprising a first end and a second end, wherein the first end is connected to the outer surface of the inner band and the second end is connected to the inner surface of the outer band and wherein at least one turbine fan airless tire vane is configured to move air in a particular direction when the inner band and outer band are both rotated in a first direction.

9. A turbine fan airless tire as recited in claim 8 wherein at least one turbine fan airless tire vane comprises a curved shape.

10. A turbine fan rim as recited in claim 8, wherein the first direction is clockwise.

11. A turbine fan rim as recited in claim 8, wherein the first direction is counter-clockwise.

12. The turbine fan airless tire as recited in claim 8, wherein an acute angle is formed between the intersection of a first line orthogonal to a plane defined by the extension end passing through the left midpoint of the turbine fan airless tire vane and a second line connecting the left midpoint of the turbine fan airless tire vane and a right point of the turbine fan airless tire vane.

13. A turbine fan airless tire as recited in claim 8, wherein the particular direction of air flow is generally toward the car side edge of the outer band and generally away from the curbside edge of the outer band.

14. A turbine fan hubcap comprising:
an inner hub comprising an outer surface and a first diameter;
an outer rim comprising an inner surface as well as a curbside edge and a car side edge and a second diameter wherein the second diameter of the outer rim is greater than the first diameter of the inner hub and wherein the outer rim is located circumferentially about the inner hub; and
at least one turbine fan hubcap vane comprising a first end and a second end wherein the first end of each turbine fan hubcap vane is connected to the outer surface of the inner hub and the second end of each turbine fan hubcap vane is connected to the inner surface of the outer rim and wherein at least one turbine fan hubcap vane is configured to move air in a particular direction when the inner hub and the outer rim are both rotated in a first direction.

15. The turbine fan hubcap as recited in claim 14, wherein at least one turbine fan hubcap vane comprises a curved shape.

16. The turbine fan hubcap as recited in claim 14, wherein at least one turbine fan hubcap vane comprises a sickle-shape and a vane extension.

17. The turbine fan hubcap as recited in claim 13, wherein an acute angle is formed between the intersection of a first line orthogonal to a plane defined by the extension end passing through the left midpoint of the turbine fan hubcap vane and a second line connecting the left midpoint of the turbine fan hubcap vane and a right point of the turbine fan hubcap vane.

18. A turbine fan hubcap as recited in claim 13, wherein the particular direction of air flow is generally toward the car side edge of the outer rim and generally away from the curbside edge of the outer rim.

19. A turbine fan hubcap as recited in claim 13, wherein the first direction is clockwise.

20. A turbine fan hubcap as recited in claim 13, wherein the first direction is counter-clockwise.

21. A method for using a turbine fan rim, the method comprising:
providing at least one turbine fan rim comprising: an inner hub having an outer surface and a first diameter; an outer rim having an inner surface as well as a curbside edge and a car side edge and a second diameter wherein the second diameter of the outer rim is greater than the first diameter of the inner hub and wherein the outer rim is located circumferentially about the inner hub; and at least one turbine fan rim vane comprising a first end and a second end wherein the first end of each turbine fan rim vane is connected to the outer surface of the inner hub and the second end of each turbine fan rim vane is connected to the inner surface of the outer rim and wherein at least one turbine fan rim vane is configured to move air in a particular direction when the inner hub and the outer rim are both rotated in a first direction;
providing a vehicle having a port side, a starboard side and an underside wherein air is located under the underside;
connecting at least one turbine fan rim to the vehicle so that rotating the inner hub and outer rim of the turbine fan rim in the first direction will cause the air located under the underside of the vehicle to be removed from under the underside of the vehicle; and
rotating the turbine fan rim in the first direction.

22. A method for using a turbine fan rim as recited in claim 21, wherein the first direction is clockwise when the turbine fan rim is connected to the starboard side of the vehicle.

23. A method for using a turbine fan rim as recited in claim 21, wherein the first direction is counter-clockwise when the turbine fan rim is connected to the port side of the vehicle.

24. A method for using a turbine fan airless tire, the method comprising:
providing at least one turbine fan airless tire comprising: an inner band comprising an outer surface and a first diameter; an outer band comprising an inner surface, a curbside edge, a car side edge and a second diameter wherein the second diameter of the outer band is greater than the first diameter of the inner band and wherein the outer band is located circumferentially about the inner band; and at least one turbine fan airless tire vane comprises a first end and a second end wherein the first end of each turbine fan airless tire vane is connected to the outer surface of the inner band and the second end of each turbine fan airless tire vane is connected to the inner surface of the outer band and wherein at least one turbine fan airless tire vane is configured to move air in a particular direction when the inner band and the outer band are both rotated in a first direction;
providing a vehicle having an underside and air located under the underside;
connecting at least one turbine fan airless tire to the vehicle so that rotating the inner band and outer band of the turbine fan airless tire in the first direction will cause the air located under the underside of the vehicle to be removed from under the underside of the vehicle; and
rotating the turbine fan airless tire in the first direction.

25. A method for using a turbine fan airless tire as recited in claim 24, wherein the first direction is clockwise when the turbine fan airless tire is connected to the starboard side of the vehicle.

26. A method for using a turbine fan airless tire as recited in claim 24, wherein the first direction is counter-clockwise when the turbine fan airless tire is connected to the port side of the vehicle.

27. A method for using a turbine fan hubcap, the method comprising:
providing at least one turbine fan hubcap comprising: an inner hub comprising an outer surface and a first diameter; an outer rim comprising an inner surface, a curbside edge, a car side edge and a second diameter wherein the second diameter of the outer rim is greater than the first diameter of the inner hub and wherein the outer rim is located circumferentially about the inner hub; and at least one turbine fan hubcap vane, comprising a first end and a second end, wherein the first end of each turbine fan hubcap vane is connected to the outer surface of the inner hub and the second end of each turbine fan hubcap vane is connected to the inner surface of the outer rim and wherein at least one turbine fan hubcap vane is configured to move air in a particular direction when the inner hub and the outer rim are both rotated in a first direction;
providing a vehicle having an underside and air located under the underside of the vehicle;
connecting at least one turbine fan hubcap to the vehicle so that rotating the inner hub and outer rim of the turbine fan hubcap in the first direction will cause air located under the underside of the vehicle to be removed from under the underside of the vehicle; and
rotating the turbine fan hubcap in the first direction.

28. A method for using a turbine fan hubcap as recited in claim 27, wherein the first direction is clockwise when the turbine fan hubcap is connected to the starboard side of the vehicle.

29. A method for using a turbine fan hubcap as recited in claim 27, wherein the first direction is counter-clockwise when the turbine fan hubcap is connected to the port side of the vehicle.
